(19) United States
(12) Patent Application Publication
(10) Pub. No.: US 2013/0049508 A1
(43) Pub. Date: Feb. 28, 2013

(54) ELECTRIC DAMPER

(71) Applicant: Marco Willems, Ingolstadt (DE)

(72) Inventor: Marco Willems, Ingolstadt (DE)

(73) Assignee: Audi AG, Ingolstadt (DE)

(21) Appl. No.: 13/500,748

(22) PCT Filed: Aug. 11, 2010
(86) PCT No.: PCT/EP2010/004895

§ 371 Date: Jun. 13, 2012

(30) Foreign Application Priority Data
Oct. 9, 2009 (DE) 10 2009 048 818.9

(51) Int. Cl. H02K 49/02

(52) U.S. Cl. 310/105

(57) ABSTRACT

An electric damper for damping the relative movement between a first and a second mass includes a generator integrated into a gear and driven by the movement of the first and second masses. A first gear element forming a stator is set into rotation by the movement of the masses. A second gear element forming a rotor is rotated by the rotation of the first gear element. The second gear element is directly or indirectly coupled to the first gear element with a gear ratio. Either the first or the second gear element includes means for generating a magnetic field.

The invention relates to an electric damper for damping relative movement between a first and a second mass and includes a generator driven by the movement of the masses.

In many technical fields, relative movements between two components of an oscillating mechanical system need to be damped. One example, which however is not limiting, relates to vibration damping in an automobile body in the region where the automobile body is suspended on the undercarriage. Predominantly, hydraulic dampers are used. However, hydraulic dampers are not capable of recovering or reusing the energy extracted from the system during damping.

DE 101 15 858 A1 discloses an electric damper with a generator driven by the movement of the masses. A generator typically includes a stator and a rotor which can rotate relative to the stator and magnetic field generating means, wherein a current is generated during the rotation of the rotor relative to the stator because the rotation takes place in the magnetic field, i.e. energy is recovered. Accordingly, damping is produced, on one hand, by the energy required for performing the rotation in the magnetic field and, on the other hand, the energy is utilized in form of a current produced by the generator, which can be supplied to the onboard network.

In the system disclosed in DE 101 15 858 A1, the generator is mounted on the vehicle body, i.e. the stator is fixedly attached to the vehicle body on a first damper part. The rotor is connected with the second damper part which can move linearly relative to the first damper part by way of a gear, for example a threaded ball spindle. The threaded spindle is received in a threaded nut fixedly connected in the second damper part. When the second damper part executes a linear motion, the threaded spindle is rotated, causing a rotary motion of the rotor. Although the ratio between the rotary motion and the linear motion of the damper can be increased to a certain extent, the described system has a very complex structure and the conversion of the linear motion into the rotary motion performed by the gear is error-prone.

The invention therefore addresses the problem of providing an electric damper with a simpler structure that operates reliably.

For solving this problem, an electric damper of the aforedescribed type is provided, wherein the generator is integrated in the gear, wherein a first gear element forming a stator is set into rotation by the movement of the masses, via which a second gear element which forms a rotor and is directly or indirectly coupled with a gear ratio by way of the first gear element is rotated, wherein means for generating a magnetic field are provided on the first or on the second gear element.

With the electric damper according to the invention, the generator is particularly advantageously integrated directly into the gear, and is not connected after the gear as in the state-of-the-art. This allows the configuration of a very small unit. In addition, the functional principle of the damper according to the invention as compared to the conventional damper is entirely novel. The stator itself is not a stationary component and is instead actively rotated during operation. I.e., the stator is in some way directly or indirectly coupled with one of the moving masses, such that the stator is set in rotation during a movement of the masses. Due to the direct or indirect coupling of the stator provided by the gear ratio, this rotation inherently causes the rotation of the second gear element forming the rotor, which rotates in the magnetic field when magnetic field generating means are provided on the stator, thus causing rotor-side current generation in current generating means provided for this purpose. I.e., only rotary motions are used or introduced into the damping system which enable damping via the generator or the generator function as well as recovery of the damping energy in form of the current generated on the generator side. When using such gear, a relatively large relative movement between the stator and the rotor, which depends only on the gear ratio, can be obtained, which can be increased further by designing the gear such that the rotation direction of the first gear element is opposite to the rotation direction of the second gear element. In other words, both gear elements rotate in opposite directions, thereby increasing the relative travel between the two gear elements during this rotary motion compared to a rotation in the same direction. With the opposing movement of the stator, the relative speed between the magnetic-field-generating elements, or the current-generating elements of the stator and the rotor is inherently also increased. Overall, a smoothing effect of the damping is attained with the opposing rotary motions, while simultaneously increasing the efficiency. The field generating means can be provided either on the stator so that the current is generated on the rotor side. Alternatively, the field generating means may also be provided in the rotor, so that current on the stator is generated in current generating means provided on the stator.

On the stator itself, i.e. on the first gear element, either several windings may be provided as field generating means, which allow external excitation, meaning that current must flow through these findings to produce the magnetic field. Alternatively, several permanent-magnetic elements may be provided on the stator for self-excitation. On the rotor itself, i.e. on the second gear element, several windings for guiding the generated current are provided as current generating means, i.e. current is induced at that location. The current can be tapped at these windings and supplied, for example, to the onboard network of an automobile having an installed damper. It will be understood that the current-generating parts can also be arranged in a reverse manner, meaning said the windings generating the magnetic field or the permanent magnets may be provided on the rotor and the induction windings on the stator.

Different types of gears may be used as gears. According to a first embodiment of the invention, the gear may be a harmonic drive gear. Such harmonic drive gear includes a ring-shaped or cylindrical flexible unit forming the first gear element and having external teeth, a rigid unit having internal teeth meshing with the external teeth of the flexible unit, and an oval rotary element forming the second gear element, which is arranged in the interior of the flexible unit and cooperates with the flexible unit while deforming the flexible unit. The field-generating windings or the field-generating permanent-magnetic elements, which form flex splines, are arranged on the flexible unit, typically referred to as flex spline, forming the stator. The rigid unit, typically also referred to as circular spline, represents a housing component of the gear and is fixedly arranged in relation to the stator and the rotor. The external teeth of the flex spline engage with the internal teeth of the circular spline, whereby the number of teeth is different, as is typical with harmonic drive gears. Lastly, an oval rotary element forming the rotor is provided, which cooperates with the flexible unit, deforms the flexible unit and thus changes the tooth engagement and/or the angular position of the tooth engagement between the external teeth of the flex spline and the internal teeth of the circular spline in a conventional manner.

When the stator is fixedly connected with a pivotally supported component, for example a transverse control arm and the like, the flex spine is twisted relative to the circular spine, resulting in a rotation of the oval rotary element, i.e. the rotor, due to a change in the deformation of the flex spine. The rotation angle of the flex spline, i.e. of the stator, is, for example, ¼ to ½ of a revolution, whereas the rotor rotates several times by 360° due to the gear ratio. The operation of the gear is therefore just the opposite of typical applications of a harmonic drive gear, wherein the rotary element is actively rotated and the flex spline operates quasi as an output.

To allow the oval rotary element to roll on the stator, i.e. the flex spline, as easily as possible, a flexible rolling bearing is advantageously arranged between the first and the second gear element, in particular a roll bearing and a needle bearing, which significantly reduces friction between the two gear elements.

An alternative type of a gear is a planetary gear. This planetary gear includes a ring gear forming the first gear element, planetary gears which are fixedly arranged on a corresponding housing component of the gear and mesh with the ring gear, and a sun gear meshing with the planetary gears and forming the second gear element. The ring gear then forms the stator which is slightly rotated by the mass to which it is coupled, for example, via a transverse control arm and the like. Because of the coupling via the planetary gears, the sun gear forming the rotor is then rotated by the stator rotation with a gear ratio, wherein the rotor is of course located inside the cylindrical or ring-shaped ring gear, thereby producing damping in connection with current generation.

A third type of gear configured to utilize the damper according to the invention is a cycloidal gear. This type of gear includes a ring-shaped or cylindrical unit which forms the first gear element and is connected with a cam disk having an edge with a tooth-shaped profile, which in turn meshes with a stationary housing part having a tooth-shaped profile, wherein a second gear element is arranged on the cam disk, preferably in a borehole, and engages with the first gear element. Such cycloidal gear also allows a high gear ratio, so that the small angular rotation of the first gear element, i.e. the stator, is transmitted to the rotor, i.e. the second gear element, with a high gear ratio. The second gear element is here eccentrically arranged on a cam disk having an outer undulated profile, with the cam disk rotating inside a stationary housing ring having a corresponding opposing toothed pattern, while being radially movable in the housing ring. In addition, the first gear element, i.e. the ring-shaped or cylindrical unit, which has corresponding coupling pins and engages in large-diameter boreholes of the cam disk, is coupled with the cam disk so that the cam disk can perform the radial movement while the first gear element, i.e. the stator, is rotation-locked on the rotation axis. The operation of such cycloidal gear is sufficiently known, and the integration of the generator here also results in excellent, smooth damping.

Other advantages, features and details of the invention are described in the following exemplary embodiments and illustrated the appended drawings, which show in:

FIG. 1 an explosive view of a damper according to the invention in a first embodiment,

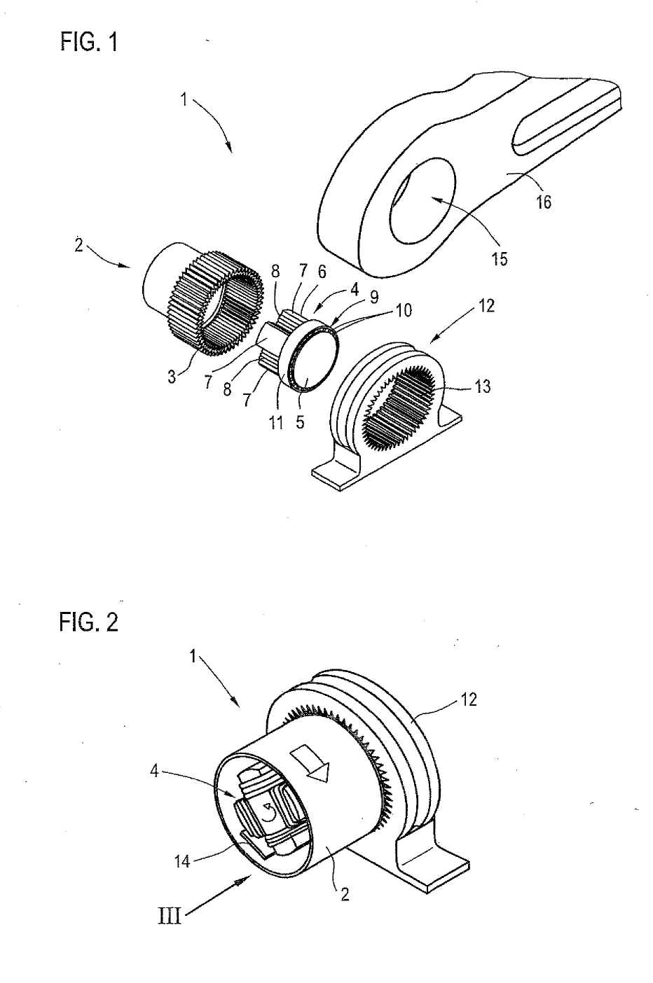

FIG. 2 the damper of FIG. 1 in an assembled view,

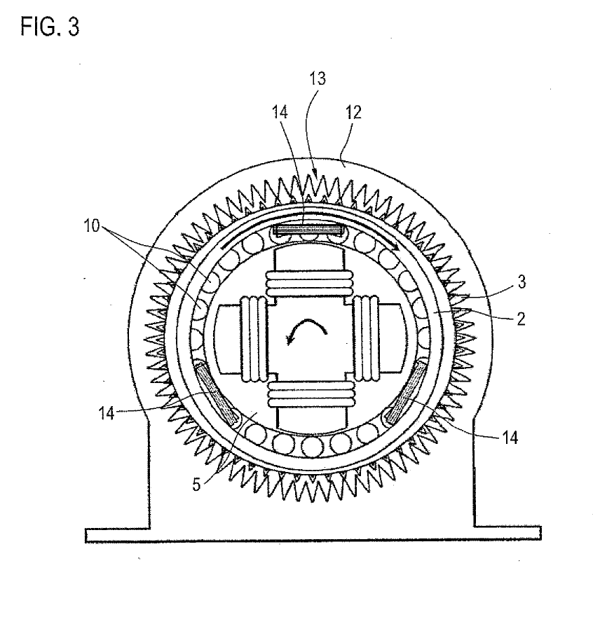

FIG. 3 a front view of the damper of FIG. 2,

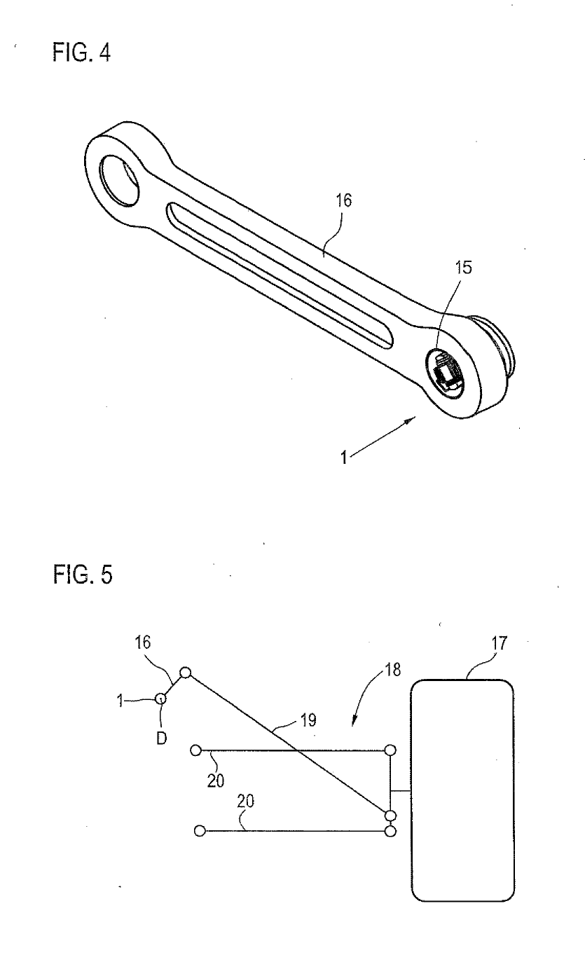

FIG. 4 a damper installed in a rocker arm,

FIG. 5 a schematic diagram of a possible installation situation of a damper in the region of an automobile axle,

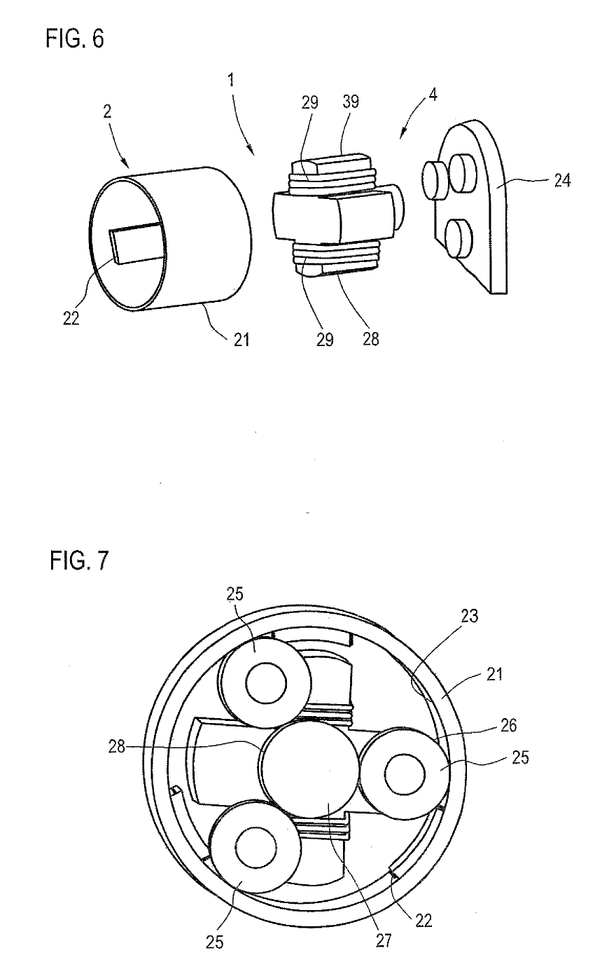

FIG. 6 an explosive view of a damper according to the invention in a second embodiment,

FIG. 7 a schematic diagram of the assembled damper of FIG. 6,

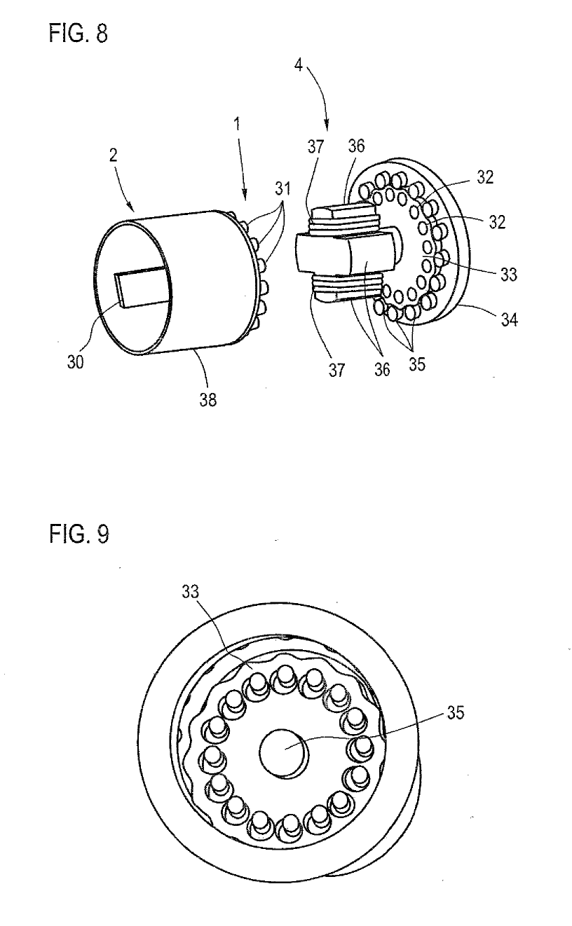

FIG. 8 an explosive view of a damper according to the invention in a third embodiment, and

FIG. 9 a perspective view of the assembled damper of FIG. 8.

FIG. 1 shows an explosive view of an electric damper 1 in a first embodiment according to the invention. The damper includes a gear in which a generator is directly integrated. The damper includes a first gear element 2 forming a stator and having means for generating a magnetic field. This first gear element 2 is formed in the illustrated gear, a harmonic drive gear, of a flexible cylindrical bushing, the so-called flex spline, which has a toothed pattern 3 on its outside. Unillustrated permanent magnets for possible self-excitation or windings for a possible external excitation for generating the magnetic field are provided on the inside.

A second gear element 4 forms the rotor, wherein this second gear element 4 is set in rotation by a rotation of the flex spline itself. To this end, the second gear element 4 includes an oval disk-shaped rotary element 5, on which an elongated body 6 is arranged which in turn has several segments 7 with windings 8, with current being induced in the windings 8 during a rotation. A flexible rolling bearing 9 with several roller-shaped and needle-shaped rolling bodies 10 and a flexible ring-shaped bearing cover 11 are arranged on the oval rotary element 5. In the assembled position, the second gear element 4 is inserted into the first gear element 2 such that the rolling bearing 9 and the flexible cover 11, respectively, contact the inside of the segment of the first gear element having the external teeth 3. The first gear element 2, i.e. the flex spline, is distorted into an oval shape by the oval rotary element 5 in conjunction with the rolling bearing 9. The oval rotary element 5 then has the function of a typically provided wave generator.

Also provided is a rigid unit 12 which is to be rigidly coupled with a third element. The rigid unit 12 has a central opening with internal teeth 13 meshing with the external teeth 3 of the first gear element 2, i.e. the flex spline. This rigid unit 12 forms the circular spline, which is known from a harmonic drive gear. Because the internal toothed pattern 3 has a smaller number of internal teeth 3 and a somewhat smaller diameter than the external toothed pattern 13, the flex splines rotate in a conventional manner like in conventional harmonic drive gears when the flex generator, in this case the rotary element 5, rotates. However, the damper according to the invention operates in the opposite manner, with the first gear element 2, i.e. the flex splines, rotating and thereby resulting in a significantly larger rotation of the second gear element 4, in this case the rotor, as a result of the gear ratio.

FIGS. 2 and 3 show the damper 1 in an installed position. As can be seen, the second gear element 4, i.e. the rotor, is located inside the first gear element 2, in this case the stator, showing on its inside an exemplary winding 14 for producing a magnetic field. The external teeth 3 of the first gear element 2 engage with the internal teeth 13 of the stationary rigid unit 12. This can be clearly seen from the diagram of FIG. 3 which shows a front view of the electric damper 1 of FIG. 1. This front view illustrates the flexible unit 2 is in addition to the rigid unit 12, when looking at the front face. However, the opposite end of the flexible first gear element having the toothed pattern is distorted into the shape of an oval by the oval rotary element 5, so that it is here also deformed into an oval with a horizontal orientation in the tooth engagement region, with the external teeth 3 being able to engage with the internal teeth 13 in this region, whereas the toothed pattern 3 is not an engagement with a toothed pattern 13 in the region of the vertical deformation axis. The deformation is caused by the oval rotary element 5 which, as described above, presses with the needle-shaped or roller-shaped rolling bearing 10 and the support 11 shaped as an exterior ring against the inside wall of the segment having the external teeth 3.

In the installed position, as shown in the example of FIG. 4, the damper 1 is inserted with the first gear element into a borehole 15 of a lever element 16, see FIG. 4. The first gear element 2, i.e. the stator and/or the flex spline, is fixedly connected with the lever element 16, so that the gear element is actively rotated by the lever 16 during a rotation about the borehole axis. This lever rotation and the resulting rotation of the first gear element 2 forces a rotation of the oval rotary element 5 via the toothed coupling and thereby of the entire second rotary element 4, causing the windings 8 to rotate in the generated magnetic field of the first gear element 2, i.e. the stator, thus inducing a current. Due to the integration into the gear and the defined gear ratio, the angle traversed by the second gear element 4 is significantly greater than the active rotation of the first gear element 2; otherwise, the two rotary motions oppose each other, as indicated in FIGS. 2 and 3 by the arrows. This necessarily results in a significant relative rotation of both elements with respect to one another, wherein the rotor rotation is a multiple of the stator rotation. For example, a rotation of the first gear element 2, i.e. the flex splines, by 90° can be transformed into a geared rotor movement in the range of 3-5 complete revolutions. Pure rotations are thus used for damping and current generation. The damping effect is due to the rotation of the rotor, i.e. the second rotary gear element 4, in the magnetic field of the first gear element 2, whereby the energy removed from the system is not lost, but is recovered to a substantial part through induction of the current.

FIG. 5A shows a possible installation situation. Illustrated are as part of an automobile a wheel 17 and a wheel carrier 18 on which a push rod 19 is arranged which is connected, for example, with the lever element 16. The lever element 16 is pivotally supported about the rotation axis D, wherein the damper 1 according to the invention is disposed in this rotation axis D. However, the damper 1 may also be integrated directly in the rotary suspensions of one or both transverse control arms 20, as illustrated in the exemplary diagram. The stator, i.e. the first gear element 2, is always connected with the drive and represents the driven element, wherein the rotor, i.e. the second gear element 4, is always the driven element. When the wheel 17 is deflected and rebounds, the lever element 16 is moved by the push rod 19, causing a rotation about the rotation axis D, thereby operating the damper 1 according to the invention in the aforedescribed manner.

FIGS. 6 and 7 show a second embodiment of a damper 1 according to the invention, wherein identical reference symbols are used for identical or substantially identical components. Because the gear is here constructed as a planetary gear, a first gear element 2 in form of a ring gear 21 is here also provided. Again, means for generating a magnetic field, for example windings 22, are provided on the inside of the ring gear 21, as well as unillustrated internal teeth 23. In the illustrated example, three planetary gears 25 which mesh with the internal teeth 23 of the ring gear 21 by way of unillustrated external teeth 26 are supported for rotation on a rigid, fixed-position support 24.

In addition, a sun gear 27 is provided, which is part of the second gear element 4 and meshes via (also unillustrated) external teeth 28 with the planetary gears 25. The sun gear 27 has an extension with corresponding sections 39 with windings 29, in which current is induced during rotation in the magnetic field.

In the installed state, the rotor, i.e. the two-part gear element 4, is disposed in the cylindrical stator, in this case the first gear element 2. When, as shown for example in FIG. 1 with respect to a first embodiment, the damper 1 is inserted in a cylindrical borehole of a pivoting lever 16 and the first gear element 2 is rigidly connected with the pivot lever 16, then a rotation of the lever about the rotation axis of the gear causes the first gear element 2, i.e. the stator, to also rotate. Due to the gear ratio via the different meshing wheels, the sun gear 27 rotates, and hence the entire second gear element rotates. The windings 29 rotate in the magnetic field produced by the windings 22 of the stator, again causing current generation. The rotation directions of the rotary element, namely of the first and the second gear element 2, 4, again oppose one another. With this exemplary embodiment of the invention, too, excellent damping can be attained in conjunction with a recovery of the energy removed from the system via the generated current.

FIGS. 8 and 9 show a third alternative embodiment of an electric damper 1 according to the invention with an eccentric gear. Here, too, a first gear element 2 forming the stator is provided. It is formed by a cylindrical sleeve, with windings 3 for producing a magnetic field arranged on the inside of the sleeve. Pins 31 are arranged on one end face, which engage in larger-diameter boreholes 32 of a cam disk 33 which has an edge with an undulated profile, see FIG. 8. Protruding pins 35 are provided on a rigid stationary unit 34 which mesh like a toothed engagement with the profile on the cam disk 33. A pin 35 of the second gear element 4 is received in a central borehole of the cam disk 33 with a rotation lock, wherein a body is in turn arranged on this pin 35, with windings 37 for generating a current arranged on respective shoulders 36 disposed on the pin 35.

When the first gear element 2, which is in turn rigidly connected with a pivoting lever 16 or the like, rotates, the cam disk 33 which meshes at the edge with the pins 35, i.e. the toothed pattern of the rigid unit 34, is actively rotated. This causes a rotation of the second gear element 4, as is known for eccentric gears or cycloidal gears of this type, wherein the rotation of the second gear element 4 is significantly greater than the applied rotation of the first gear element 2 as a result of the gear ratio.

A central feature of the different types of the dampers according to the invention is that the generator is always directly integrated in the gear itself, independent of the employed gear type. An additional central feature is that the stator, i.e. the element generating the exciting magnetic field, which is formed here by the hollow-cylindrical first gear element 1, is during a movement of the masses always actively rotated via a pivoting lever and the like, which is for example the case when a wheel rebounds during installation in an automobile. The respective gear ratio causes a significantly greater rotation of the armature, formed by the respective second gear element, which allows commensurate high current generation efficiency.

While the magnetic field is in the aforedescribed exemplary embodiments always generated by stator-side means, whereas the current is generated on the rotor side, a reverse arrangement of the current-generating components would also be possible, i.e. the magnetic field generating means are arranged on the rotor, whereas the current is induced in windings arranged on the stator side.

1.-8. (canceled)

9. An electric damper for damping relative movement between a first and a second mass, comprising:
a generator driven by the movement between the first and the second mass, said generator being integrated into a gear comprising a first gear element forming a stator and being set into rotation by the movement between the first and the second mass, and a second gear element forming a rotor and rotated by rotation of the first gear element, said second gear element coupled directly or indirectly to the first gear element with a gear ratio, and
means for generating a magnetic field disposed on the first gear element or the second gear element.

10. The damper of claim 9, wherein the means for generating a magnetic field comprise a plurality of windings disposed on the first gear element for external excitation or several permanent-magnetic elements for self-excitation, and wherein the second gear element comprises a plurality of windings for guiding a generated current.

11. The damper of claim 9, wherein the means for generating a magnetic field comprise a plurality of windings disposed on the second gear element for external excitation or several permanent-magnetic elements for self-excitation, and wherein the first gear element comprises a plurality of windings for guiding a generated current.

12. The damper of claim 9, wherein the second gear element is ring-shaped or cylindrical, and the first gear element arranged interiorly of the first gear element.

13. The damper of claim 9, wherein the first gear element is ring-shaped or cylindrical, and the second gear element arranged interiorly of the first gear element.

14. The damper of claim 9, wherein a rotation direction of the first gear element opposes a rotation direction of the second gear element.

15. The damper of claim 9, wherein the gear is a harmonic drive gear comprising:
a ring-shaped or cylindrical flexible unit forming the first gear element and having external teeth,
a rigid unit with internal teeth meshing with the external teeth of the flexible unit, and
an oval rotary element arranged interiorly of the flexible unit and cooperating with the flexible unit and deforming the flexible unit.

16. The damper of claim 15, further comprising a flexible rolling bearing arranged between the first gear element and the second gear element.

17. The damper of claim 16, wherein the flexible rolling bearing is constructed as a roller bearing or as a needle bearing.

18. The damper of claim 9, wherein the gear is a planetary gear comprising:
a ring gear forming the first gear element,
planet gears meshing with the ring gear, and
a sun gear meshing with the planetary gears and forming the second gear element.

19. The damper of claim 9, wherein the gear is a cycloidal gear comprising:
a ring-shaped or cylindrical unit forming the first gear element,
a stationary housing part having a first toothed profile, and
a cam disk connected to the first gear element and having an edge with a second toothed profile meshing with the first toothed profile,
wherein the second gear element engaging with the first gear element is arranged on the cam disk.

20. The damper of claim 19, wherein the second gear element is disposed in a borehole of the cam disk.
